(19) United States
(12) Patent Application Publication
(10) Pub. No.: US 2007/0088917 A1
(43) Pub. Date: Apr. 19, 2007

(54) System and method for creating and maintaining a logical serial attached SCSI communication channel among a plurality of storage systems

(76) Inventors: Samantha L. Ranaweera, Cranberry Township, PA (US); Daniel J. Kolor, Cranberry Township, PA (US)

Correspondence Address: CESARI AND MCKENNA, LLP, 88 BLACK FALCON AVENUE, BOSTON, MA, 02210, US

(21) Appl. No.: 11/250,538

(22) Filed: Oct. 14, 2005

(51) Int. Cl. G06F 12/00

(52) U.S. Cl. 711/148

(57) ABSTRACT

A system and method creates and maintains a serial attached SCSI (SAS) logical communication channel among a plurality of storage systems. The storage systems utilize a SAS expander to form a SAS domain comprising a plurality of storage systems and/or storage devices. A target mode module and a logical channel protocol module executing on each storage system enable storage system to storage system messaging via the SAS domain.

### FIELD OF THE INVENTION

The present invention relates to storage systems and, in particular, to a creating and maintaining a logical communication channel among a plurality of storage systems using serial attached SCSI (SAS).

### BACKGROUND OF THE INVENTION

A storage system is a computer that provides storage service relating to the organization of information on writeable persistent storage devices, such as memories, tapes or disks. The storage system is commonly deployed within a storage area network (SAN) or a network attached storage (NAS) environment. When used within a NAS environment, the storage system may be embodied as a file server including an operating system that implements a file system to logically organize the information as a hierarchical structure of directories and files on, e.g. the disks. Each “on-disk” file may be implemented as a set of data structures, e.g., disk blocks, configured to store information, such as the actual data for the file. A directory, on the other hand, may be implemented as a specially formatted file in which information about other files and directories are stored.

The storage system may be further configured to operate according to a client/server model of information delivery to thereby allow many client systems (clients) to access shared resources, such as files, stored on the storage system. Sharing of files is a hallmark of a NAS system, which is enabled because of semantic level of access to files and file systems. Storage of information on a NAS system is typically deployed over a computer network comprising a geographically distributed collection of interconnected communication links, such as Ethernet, that allow clients to remotely access the information (files) on the file server. The clients typically communicate with the storage system by exchanging discrete frames or packets of data according to pre-defined protocols, such as the Transmission Control Protocol/Internet Protocol (TCP/IP).

In the client/server model, the client may comprise an application executing on a computer that “connects” to the storage system over a computer network, such as a point-to-point link, shared local area network, wide area network or virtual private network implemented over a public network, such as the Internet. NAS systems generally utilize file-based access protocols; therefore, each client may request the services of the storage system by issuing file system protocol messages (in the form of packets) to the file system over the network. By supporting a plurality of file system protocols, such as the conventional Common Internet File System (CIFS), the Network File System (NFS) and the Direct Access File System (DAFS) protocols, the utility of the storage system may be enhanced for networking clients.

A SAN is a high-speed network that enables establishment of direct connections between a storage system and its storage devices. The SAN may thus be viewed as an extension to a storage bus and, as such, an operating system of the storage system enables access to stored information using block-based access protocols over the “extended bus”. In this context, the extended bus is typically embodied as Fibre Channel (FC) or Ethernet media adapted to operate with block access protocols, such as Small Computer Systems Interface (SCSI) protocol encapsulation over FC (FCP) or TCP/IP/Ethernet (iSCSI). A SAN arrangement or deployment allows decoupling of storage from the storage system, such as an application server, and some level of storage sharing at the application server level. There are, however, environments wherein a SAN is dedicated to a single server. When used within a SAN environment, the storage system may be embodied as a storage appliance that manages data access to a set of disks using one or more block-based protocols, such as SCSI embedded in Fibre Channel (FCP). One example of a SAN arrangement, including a multi-protocol storage appliance suitable for use in the SAN, is described in U.S. patent application Ser. No. 10/215,917, entitled MULTI-PROTOCOL STORAGE APPLIANCE THAT PROVIDES INTEGRATED SUPPORT FOR FILE AND BLOCK ACCESS PROTOCOLS, by Brian Pawlowski, et al.

It is advantageous for the services and data provided by a storage system to be available for access to the greatest degree possible. Accordingly, some storage system environments provide a plurality of storage systems in a cluster, with a property that when a first storage system fails, a second storage system (“partner”) is available to take over and provide the services and the data otherwise provided by the first storage system. When the first storage system fails a failover operation is initiated wherein the second partner storage system in the cluster assumes the tasks of processing and handling any data access requests normally processed by the first storage system. This may be accomplished by the partner storage system assuming the identity of the failed storage system. Data access requests directed to the failed storage system are then routed to the partner storage system for processing. One such example of a storage system cluster configuration is described in U.S. patent application Ser. No. 10/421,297, entitled SYSTEM AND METHOD FOR TRANSPORT-LEVEL FAILOVER OF FCP DEVICES IN A CLUSTER, by Arthur F. Lent, et al. Additionally, an administrator may desire to take a storage system offline for a variety of reasons including, for example, to upgrade hardware, etc. In such situations, it may be advantageous to perform a user-initiated takeover operation, as opposed to a failover operation. After the takeover operation is complete, the storage system's data is serviced by its partner until a giveback operation is performed.

FIG. 1 is a schematic block diagram of an exemplary storage system network environment 100 showing a conventional cluster arrangement. The environment 100 comprises a network cloud 102 coupled to a client 104. The client 104 may be a general-purpose computer, such as a PC or a workstation, or a special-purpose computer, such as an application server, configured to execute applications over an operating system that includes block access protocols. A storage system cluster 130, comprising Red Storage System 300A and Blue Storage System 300B, is also connected to the cloud 102. These storage systems are illustratively configured to control storage of and access to interconnected storage devices, such as disks residing on disk shelves 112 and 114.

In the illustrated example, Red Storage System 300A is connected to Red Disk Shelf 112 via an A port 116 of the system 300A. The Red Storage System 300A also accesses Blue Disk Shelf 114 via its B port 118. Likewise, Blue Storage System 300B accesses Blue Disk Shelf 114 via A port 120 and Red Disk Shelf 112 through B port 122. Thus each disk shelf in the cluster is accessible to each storage system, thereby providing redundant data paths in the event of a failover.

Connecting the Red and Blue Storage Systems 300A, B is a cluster interconnect 110, which provides a communication link between the two storage systems. The storage systems, and the storage operating system executing thereon, utilize the cluster interconnect 110 to form a logical communication channel for inter-storage system communication. The logical communication channel over the cluster interconnect is utilized by various processes executing on the storage systems. Examples of processes utilizing the cluster interconnect include failover monitors and proxying processes, which are further described in U.S. patent application Ser. No. 10/622,558, entitled SYSTEM AND METHOD FOR RELIABLE PEER COMMUNICATION IN A CLUSTERED STORAGE SYSTEM, by Abhijeet Gole and Joydeep sen Sarma. These processes may utilize the cluster interconnect to transfer various messages to processes executing on another storage system. The cluster interconnect 110 can be of any suitable communication medium, including, for example, an InfiniBand connection or a Fibre Channel (FC) data link.

However, a noted disadvantage of using of InfiniBand and/or FC is the relatively high cost associated with dedicating an InfiniBand and/or FC controller for use as a cluster interconnect. The addition of such a dedicated interconnect device may significantly increase the cost of a single storage system. Additionally, to ensure that the cluster interconnect is highly available, i.e., that messages may be passed between the storage systems in the event of an InfiniBand/FC controller failure, each storage system ideally includes a plurality of InfiniBand and/or FC controllers for use as cluster interconnects. Such redundancy exacerbates the cost issues involved with using these forms of transport media for storage system to storage system communication.

### SUMMARY OF THE INVENTION

The present invention overcomes the disadvantages of the prior art by providing a system and method for creating and maintaining a logical serial attached SCSI (SAS) communication channel that permits messages to be passed among a plurality of storage systems. Each storage system executes a storage operating system that includes a target mode module, which permits the storage system to function as a SCSI target to thereby receive and process SCSI commands directed to it from SCSI initiators. Each storage system further includes a SAS controller and, in the illustrative embodiment, a SAS expander that permits a plurality of devices to be operatively interconnected with the SAS controller. The use of SAS controllers and expanders reduces the number of components that are necessary for full operation, thereby reducing the number of points of failure in a storage system.

During initialization of the storage system, the SAS target mode module operates in conjunction with the SAS controller to perform an iterative discovery operation to identify all devices connected to a SAS domain. The SAS domain comprises all SAS devices addressable by a SAS controller, including, e.g., end devices such as disks, SAS expanders and other storage systems having a SAS target mode module. The discovery operation identifies the SAS address of each device in the SAS domain along with the type of device.

The logical SAS communication channel of the present invention permits interprocess communication among processes executing on different storage systems. When am initiating process executing on an initiator storage system desires to transfer a message to a target process on a target storage system, the initiating process generates the message and then passes the message to a logical channel protocol module (LCPM) executing on the initiator storage system. The LCPM manages communication over the logical communication channel for processes within the storage system. The LCPM constructs a SCSI write operation encapsulating the message and passes the write operation to the SAS initiator module on the initiator storage system. The SAS initiator module, in cooperation with the SAS controller, transmits the write operation onto the SAS domain where it is received by the SAS controller of the target storage system. The SAS controller on the target storage system alerts the SAS target mode module on the target storage system, which then prepares an appropriate buffer for the write data. The two SAS controllers cooperate to transfer the data from the initiator to the target storage system. The target SAS controller then alerts the target mode module that the write operation has completed. The SAS target mode module extracts the write data and passes it to the LCPM on the target storage system, which extracts the message and passes the message to the appropriate target process on the target storage system.

### BRIEF DESCRIPTION OF THE DRAWINGS

The above and further advantages of invention may be understood by referring to the following description in conjunction with the accompanying drawings in which like reference numerals indicate identical or functionally similar elements:

FIG. 1, previously described, is a schematic block diagram of an exemplary storage system cluster environment;

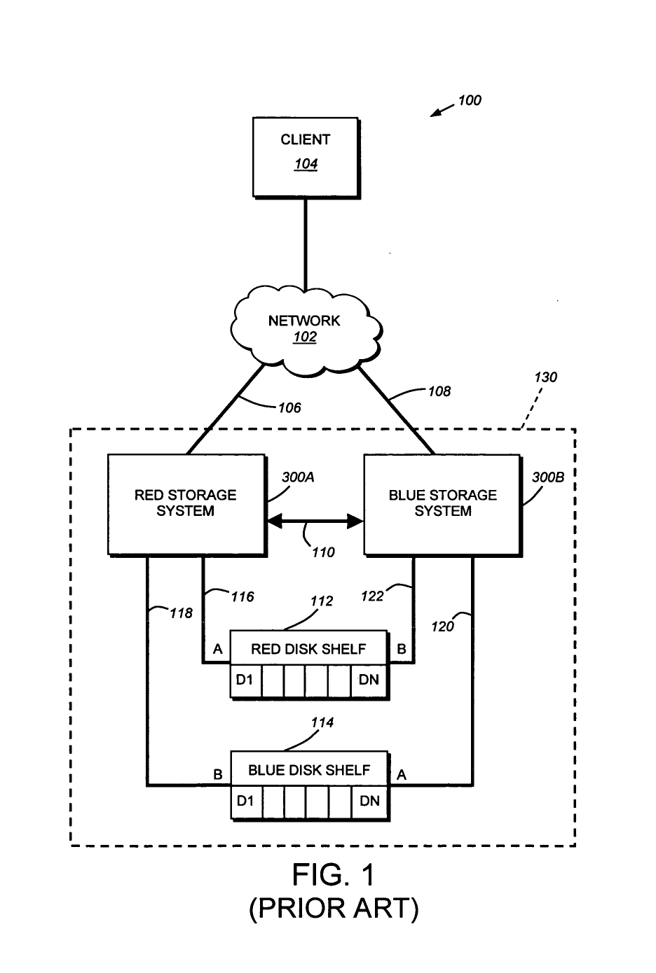

FIG. 2 is a schematic block diagram of a storage system environment in accordance with an embodiment of the present invention;

FIG. 3 is a schematic block diagram of a storage system in accordance with an embodiment of the present invention;

FIG. 4 is a schematic block diagram of a storage operating system in accordance with an embodiment of the present invention;

FIG. 5 is a flowchart detailing the steps of a procedure for initializing a serial attached SCSI (SAS) controller in accordance with an embodiment of the present invention; and

FIG. 6 is a flowchart detailing the steps of a procedure for sending a message using a logical communication channel over a SAS domain in accordance with an embodiment of the present invention.

### DETAILED DESCRIPTION OF ILLUSTRATIVE EMBODIMENTS

A. Clustered Storage System Environment

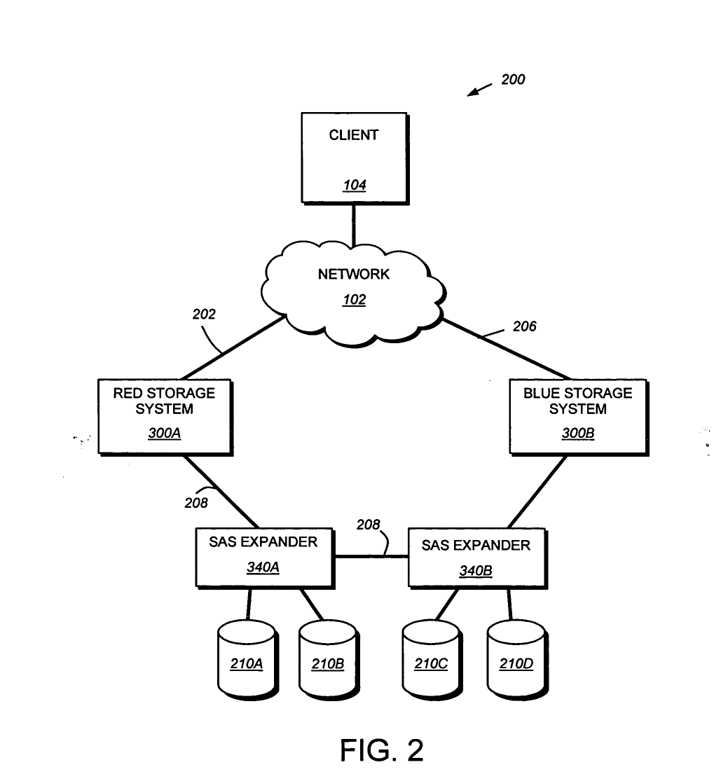

FIG. 2 is a schematic block diagram of an exemplary network environment 200 in which the principles of the present invention may be implemented. The environment 200 comprises a network 102 coupled to one or more clients 104. Each client 104 may be a general-purpose computer, such as a PC or a workstation, or a special-purpose computer, such as an application server, configured to execute applications over an operating system that includes block access protocols. A Red Storage System 300A and Blue Storage System 300B are also connected to the network 102. These storage systems, described further below, are configured to control storage of, and access to, interconnected storage devices, such as disks 210.

The Red and Blue storage systems 300 A, B are connected to the network 102 via “front-end” data pathways 202, 206 respectively. These front-end data pathways 202, 206 may comprise direct point-to-point links or may represent alternate data pathways including various intermediate network devices, such as routers, switches, hubs, etc.

Operatively interconnected with each storage system is a serial attached SCSI (SAS) expander 340A, B. SAS is described in Serial Attached SCSI 1.1 (SAS-1.1) Revision 9d, published on May 30, 2005 by the T10 Technical Committee of the International Committee for Information Technology Standards (INCITS), which is hereby incorporated by reference. SAS expanders provide a plurality of SAS ports, each of which may comprise one or more phys that may be connected to various SAS devices. A phy, as defined by the SAS-1.1 specification, is an object within a SAS device that is utilized to interface with other devices within a SAS domain. A phy may comprise a transceiver and one or more electrical interfaces to a physical link to communicate with other phys.

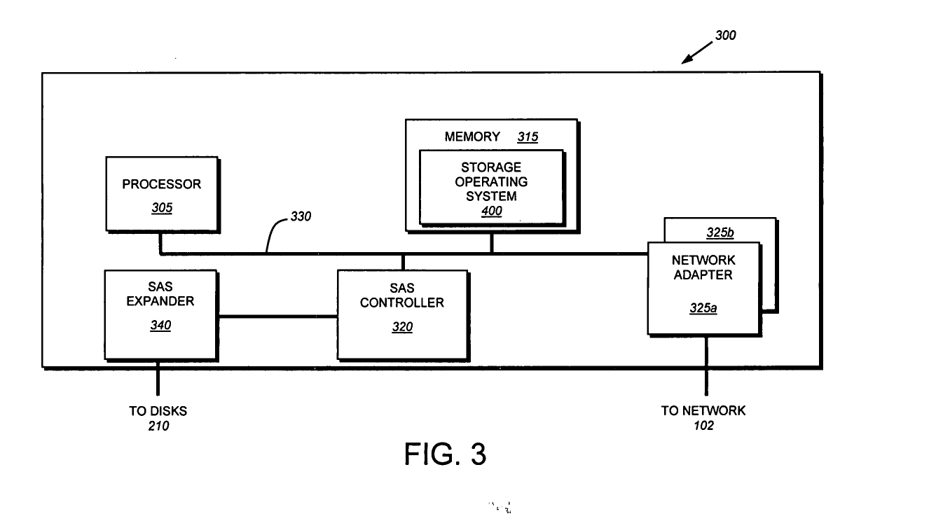

Illustratively, the SAS expanders 340A, B are operatively interconnected with the storage systems 300 A, B and with the plurality of disks 210. SAS expanders may also be interconnected with other SAS expanders such as via connection 208. SAS expanders may be separate SAS devices as shown in environment 200 or may be, as is shown in FIG. 3, incorporated into storage systems 300. As such, it should be noted that the description of SAS expanders 340 being separate network devices should be taken as exemplary only.

In environment 200, storage systems 300 manage data stored on storage devices 210 by passing SAS commands onto the SAS domain, which comprises SAS controllers 320 (see FIG. 3) within the storage systems, the SAS expanders 340, the storage devices 210 and any other SAS devices that are operatively interconnected therewith. Storage device 210 may have one or more connections with SAS expanders 340 to provide redundant data pathways.

Notably, no cluster interconnect is provided in environment 200. Instead, the logical SAS communication channel of the present invention, as described further below, is utilized in place of the cluster interconnect. As each storage system does not need one or more dedicated FC/InfiniBand controllers to function as a cluster interconnect device, the total cost of storage system environment 200 is reduced. It should be further noted that in alternate embodiments, a conventional cluster interconnect device may be utilized in conjunction with the logical communication channel of the present invention. As such, the description of storage systems 300 not having a cluster interconnect device should be taken as exemplary only.

B. Storage System

FIG. 3 is a schematic block diagram of an exemplary storage system 300 configured to provide storage service relating to the organization of information on storage devices, such as disks. The storage system 300 illustratively comprises a processor 305, a memory 315, a plurality of network adapters 325a, 325b and a SAS controller 320 interconnected by a system bus 330. A storage system is a computer having features such as simplicity of storage service management and ease of storage reconfiguration, including reusable storage space, for users (system administrators) and clients of network attached storage (NAS) and storage area network (SAN) deployments. The storage system may provide NAS services through a file system, while the same system provides SAN services through SAN virtualization, including logical unit number (lun) emulation. An example of such a storage system is described in the above-referenced U.S. patent application Ser. No. 10/215,917 entitled MULTI-PROTOCOL STORAGE APPLIANCE THAT PROVIDES INTEGRATED SUPPORT FOR FILE AND BLOCK ACCESS PROTOCOLS by Brian Pawlowski, et al. The storage system 300 also includes a storage operating system 400 that provides a virtualization system to logically organize the information as a hierarchical structure of directory, file and virtual disk (vdisk) storage objects on the disks.

Whereas clients of a NAS-based network environment have a storage viewpoint of files, the clients of a SAN-based network environment have a storage viewpoint of blocks or disks. To that end, the storage system 300 presents (exports) disks to SAN clients through the creation of luns or vdisk objects. A vdisk object (hereinafter “vdisk”) is a special file type that is implemented by the virtualization system and translated into an emulated disk as viewed by the SAN clients. Such vdisks objects are further described in U.S. patent application Ser. No. 10/216,453 entitled STORAGE VIRTUALIZATION BY LAYERING VIRTUAL DISK OBJECTS ON A FILE SYSTEM, by Vijayan Rajan, et al. The storage system thereafter makes these emulated disks accessible to the SAN clients through controlled exports.

In the illustrative embodiment, the memory 315 comprises storage locations that are addressable by the processor and adapters for storing software program code and data structures associated with the present invention. The processor and adapters may, in turn, comprise processing elements and/or logic circuitry configured to execute the software code and manipulate the data structures. The storage operating system 400, portions of which are typically resident in memory and executed by the processing elements, functionally organizes the storage system by, inter alia, invoking storage operations in support of the storage service implemented by the storage system. It will be apparent to those skilled in the art that other processing and memory means, including various computer readable media, may be used for storing and executing program instructions pertaining to the inventive system and method described herein.

The network adapters 325a and b couple the storage system to clients over point-to-point links, wide area networks (WAN), virtual private networks (VPN) implemented over a public network (Internet) or a shared local area network (LAN) or any other acceptable networking architecture. The network adapters 325a, b also couple the storage system 300 to clients 104 that may be further configured to access the stored information as blocks or disks. The network adapters 325 may comprise a FC host bus adapter (HBA) having the mechanical, electrical and signaling circuitry needed to connect the storage appliance 300 to the network 102. In addition to providing FC access, the FC HBA may offload FC network processing operations from the storage appliance's processor 305. The FC HBAs 325 may include support for virtual ports associated with each physical FC port. Each virtual port may have its own unique network address comprising a WWPN and WWNN. It should be noted that while this description has been written in terms of two network adapters 325a, b, the teachings of the present invention may be implemented in a storage system having one or more network adapters. As such, the description of the network adapters should be taken as exemplary only.

The clients 104 may be general-purpose computers configured to execute applications over a variety of operating systems, including the UNIX® and Microsoft® Windows™ operating systems. The clients generally utilize block-based access protocols, such as the Small Computer System Interface (SCSI) protocol, when accessing information (in the form of blocks, disks or vdisks) over a SAN-based network. SCSI is a peripheral input/output (I/O) interface with a standard, device independent protocol that allows different peripheral devices, such as disks, to attach to the storage appliance 300.

The storage system 300 supports various SCSI-based protocols used in SAN deployments, including SCSI encapsulated over TCP (iSCSI) and SCSI encapsulated over FC (FCP). The clients may thus request the services of the storage system 300 by issuing iSCSI and/or FCP messages over the network 102 to access information stored on the disks. It will be apparent to those skilled in the art that the clients may also request the services of the integrated storage appliance using other block access protocols. By supporting a plurality of block access protocols, the storage system provides a unified and coherent access solution to vdisks/luns in a heterogeneous SAN environment.

The SAS controller 320 cooperates with the storage operating system 400 executing on the storage system to access information requested by the clients. The information may be stored on the disks or other similar media adapted to store information. The SAS controller includes the I/O interface circuitry that implements SAS. Illustratively, the SAS controller 320 is implemented in hardware. However, in alternate embodiments, the SAS controller 320 may be implemented using hardware, software, firmware or a combination thereof. As such, the description of SAS controller comprising hardware should be taken as exemplary only.

The information is retrieved by the SAS controller and, if necessary, processed by the processor 305 (or the controller 320 itself) prior to being forwarded over the system bus 330 to the network adapters 325a and b, where the information is formatted into packets or messages and returned to the clients. In accordance with an illustrative embodiment of the present invention a SAS expander 340 is operatively interconnected with the SAS controller 320. As noted above, the SAS expander 340 may be internal to the storage system 300 or may be a separate SAS device, as shown in FIG. 2. The SAS expander 340 provides a plurality of ports, each with one or more phys, that may be addressed by SAS controller 320.

Storage of information on the storage system 300 is, in the illustrative embodiment, implemented as one or more storage volumes that comprise a cluster of physical storage disks, defining an overall logical arrangement of disk space. The disks within a volume are typically organized as one or more groups of Redundant Array of Independent (or Inexpensive) Disks (RAID). RAID implementations enhance the reliability/integrity of data storage through the writing of data “stripes” across a given number of physical disks in the RAID group, and the appropriate storing of redundant information with respect to the striped data. The redundant information enables recovery of data lost when a storage device fails.

Specifically, each volume is constructed from an array of physical disks that are organized as RAID groups. The physical disks of each RAID group include those disks configured to store striped data and those configured to store parity for the data, in accordance with an illustrative RAID 4 level configurations. However, other RAID level configurations (e.g. RAID 5) are also contemplated. In the illustrative embodiment, a minimum of one parity disk and one data disk may be employed.

To facilitate access to the disks, the storage operating system 400 implements a write-anywhere file system that cooperates with virtualization system code to provide a function that “virtualizes” the storage space provided by the disks. The file system logically organizes the information as a hierarchical structure of directory and file objects (hereinafter “directories” and “files”) on the disks. Each “on-disk” file may be implemented as set of disk blocks configured to store information, such as data, whereas the directory may be implemented as a specially formatted file in which names and links to other files and directories are stored. The virtualization system allows the file system to further logically organize information as vdisks on the disks, thereby providing an integrated NAS and SAN storage system approach to storage by enabling file-based (NAS) access to the files and directories, while further emulating block-based (SAN) access to the vdisks on a file-based storage platform.

As noted, a vdisk is a special file type in a volume that derives from a plain (regular) file, but that has associated export controls and operation restrictions that support emulation of a disk. Unlike a file that can be created by a client using, e.g., the NFS or CIFS protocol, a vdisk is created on the storage system via, e.g. a user interface (UI) as a special typed file (object). Illustratively, the vdisk is a multi-inode object comprising a special file inode that holds data and at least one associated stream inode that holds attributes, including security information. The special file inode functions as a main container for storing data associated with the emulated disk. The stream inode stores attributes that allow luns and exports to persist over, e.g., reboot operations, while also enabling management of the vdisk as a single disk object in relation to SAN clients.

In addition, it will be understood to those skilled in the art that the inventive technique described herein may apply to any type of special-purpose (e.g., storage serving appliance) or general-purpose computer, including a standalone computer or portion thereof, embodied as or including a storage system. Moreover, the teachings of this invention can be adapted to a variety of storage system architectures including, but not limited to, a network-attached storage environment, a storage area network and disk assembly directly-attached to a client or host computer. The term “storage system” should therefore be taken broadly to include such arrangements in addition to any subsystems configured to perform a storage functions and associated with other equipment or systems.

C. Storage Operating System

In the illustrative embodiment, the storage operating system is the NetApp® Data ONTAP™ operating system that implements a Write Anywhere File Layout (WAFL®) file system. However, it is expressly contemplated that any appropriate file system, including a write in-place file system, may be enhanced for use in accordance with the inventive principles described herein. As such, where the term “WAFL” is employed, it should be taken broadly to refer to any file system that is otherwise adaptable to the teachings of this invention.

As used herein, the term “storage operating system” generally refers to the computer-executable code operable on a computer that manages data access and may, in the case of a storage appliance, implement data access semantics, such as the Data ONTAP storage operating system, which is implemented as a microkernel. The storage operating system can also be implemented as an application program operating over a general-purpose operating system, such as UNIX® or Windows XP®, or as a general-purpose operating system with configurable functionality, which is configured for storage applications as described herein.

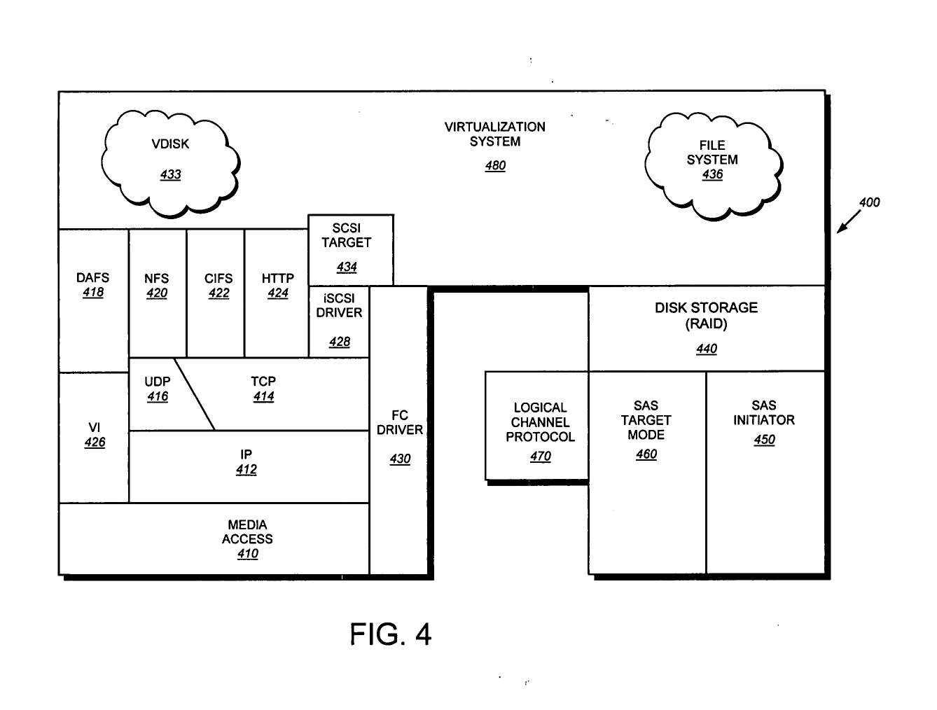

FIG. 4 is a schematic block diagram of the storage operating system 400 that may be advantageously used with the present invention. The storage operating system comprises of a series of software layers organized to form an integrated network protocol stack or multi-protocol engine that provides data paths for clients to access information stored on the storage system using block and file access protocols. The protocol stack includes a media access layer 410 of network drivers (e.g., gigabit Ethernet drivers) that interfaces to network protocol layers, such as the IP layer 412 and its supporting transport mechanisms, the TCP layer 414 and the User Datagram Protocol (UDP) layer 416. A file system protocol layer provides multi-protocol file access and, to that end, includes support for the Direct Access File System (DAFS) protocol 418, the NFS protocol 420, the CIFS protocol 422 and the Hypertext Transfer Protocol (HTTP) protocol 424. A Virtual Interface (VI) layer 426 implements the VI architecture to provide direct access transport (DAT) capabilities, such as Remote Direct Memory Access (RDMA), as required by the DAFS protocol 418.

An iSCSI driver layer 428 provides block protocol access over the TCP/IP network protocol layers, while a FC driver layer 430 operates with the FC HBA 325 to receive and transmit block access requests and responses to and from the integrated storage appliance. The FC and iSCSI drivers provide FC-specific and iSCSI-specific access control to the luns (vdisks) and, thus, manage exports of vdisks to either iSCSI or FCP or, alternatively, to both iSCSI and FCP when accessing a single vdisk on the storage system. In addition, the storage operating system includes a disk storage layer 440 that implements a disk storage protocol, such as a RAID protocol, and a SAS initiator module 450 that operates in conjunction with the SAS controller 320 to implement SAS initiator operations such as input/output operations directed to storage devices 210.

A SAS target mode module 460 operates in conjunction with a logical channel protocol module (LCPM) 470 to implement the logical communication channel of the present invention. In addition, the SAS target mode module 460 operates in conjunction with the SAS controller 320 to enable the storage system to function as a SAS target. Moreover, the LCPM 470 co-operates with various other processes (not shown) to manage the transmission/reception of messages over the logical SAS communication channel of the present invention. Illustratively, the LCPM 470 provides an application program interface (API) that other processes within the storage operating system may utilize in passing messages to processes executing on other storage systems.

Bridging the disk software layers with the integrated network protocol stack layers is a virtualization system 480 that is implemented by a file system 436 interacting with virtualization software embodied as, e.g., vdisk module 433, and SCSI target module 434. These modules may be implemented as software, hardware, firmware or a combination thereof. The vdisk module 433 manages SAN deployments by, among other things, implementing a comprehensive set of vdisk (lun) commands that are converted to primitive file system operations (“primitives”) that interact with the file system 436 and the SCSI target module 434 to implement the vdisks.

The SCSI target module 434, in turn, initiates emulation of a disk or lun by providing a mapping procedure that translates luns into the special vdisk file types. The SCSI target module is illustratively disposed between the FC and iSCSI drivers 428, 430 and the file system 436 to thereby provide a translation layer of the virtualization system 480 between the SAN block (lun) space and the file system space, where luns are represented as vdisks. By “disposing” SAN virtualization over the file system 436, the multi-protocol storage appliance reverses the approaches taken by prior systems to thereby provide a single unified storage platform for essentially all storage access protocols.

The file system 436 illustratively implements a write anywhere file system having an on-disk format representation that is block-based using, e.g., 4 kilobyte (KB) blocks and using inodes to describe the files. A further description of the structure of the illustrative file system is provided in U.S. Pat. No. 5,819,292, titled METHOD FOR MAINTAINING CONSISTENT STATES OF A FILE SYSTEM AND FOR CREATING USER-ACCESSIBLE READ-ONLY COPIES OF A FILE SYSTEM by David Hitz, et al., issued Oct. 6, 1998, which patent is hereby incorporated by reference as though fully set forth herein.

D. Target Mode Initialization

The present invention provides a system and method for creating and maintaining a logical SAS communication channel that permits messages to be passed among a plurality of storage systems. Each storage system executes a storage operating system that includes a SAS target mode module, which permits the storage system to function as a SCSI target to thereby receive and process SCSI commands directed to it from SCSI initiators. Each storage system further includes a SAS controller and, in the illustrative embodiment, a SAS expander that permits a plurality of devices to be operatively interconnected with the SAS controller.

During initialization of the storage system, the SAS target mode module operates in conjunction with the SAS controller to perform an iterative discovery operation to identify all devices connected to a SAS domain. The SAS domain comprises all SAS devices addressable by a SAS controller, including, e.g., end devices such as disks, SAS expanders and other storage systems having a SAS target mode module. The discovery operation identifies the SAS address of each of the devices in the SAS domain along with the type of device.

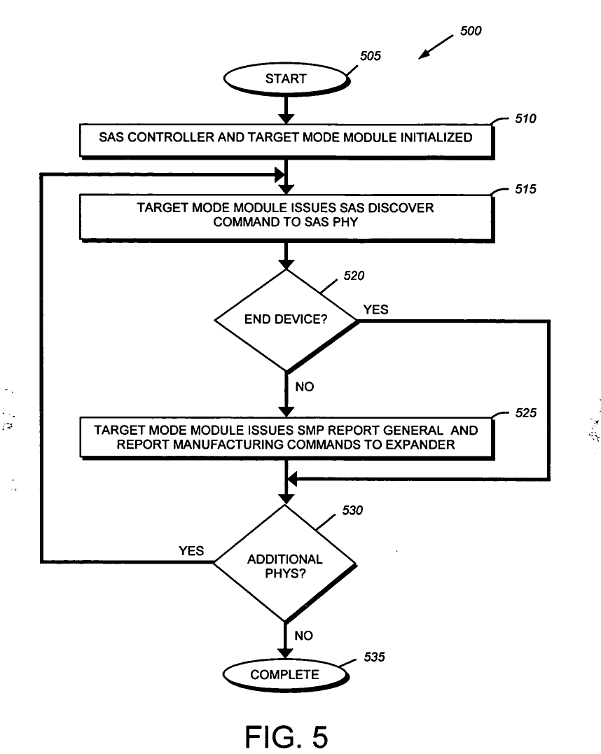

FIG. 5 is a flowchart detailing the steps of a procedure 500 for initializing the SAS target mode module and performing SAS domain discovery in accordance with an embodiment of the present invention. The procedure 500 begins in step 505 and continues to step 510 where the SAS controller and the target mode module of the storage system are initialized. This initialization may occur by, for example, an initial power on of a storage system. In response, the target mode module, in step 515, issues a SAS DISCOVER function to a SAS phy that is visible to the SAS controller in the storage system. In response, the phy identifies the type of device connected thereto, e.g., a disk device, a SAS expander device, etc. The target mode module then determines, in step 520, whether the identified device is an end device such as a disk drive, a printer or other SCSI device other than an SAS expander. If the device is an end device, the target mode module notes the SAS address of the device and then branches to step 530 and determines if there are any additional phys to be discovered. If there are no additional phys to be discovered, the procedure then completes in step 535. Otherwise, the procedure loops back to step 515 where the SAS target mode module issues a SAS DISCOVER command to another phy that is visible to SAS controller 320.

If, in step 520, it is determined that the device is not an end device, then the device is a SAS expander, the procedure proceeds to step 525 where the target mode module issues SMP REPORT GENERAL and REPORT MANUFACTURING commands to the SAS expander. In response, the SAS expander replies with a list of any SAS phys to which it is connected. The target mode module notes these identified phys and in step 530, determines if there are any additional phys to discover. If so, the procedure loops back to step 515. Otherwise, at the completion of procedure 500, the SAS controller and target mode module have constructed a view of the SAS topology to which the SAS controller is connected.

E. Target Mode Message Passing

The logical SAS communicator channel described herein fewer permits interprocess communication among processors executing on different storage systems. When an initiating process executing on an initiator storage system desires to transfer a message to a target process on a target storage system, the initiating process generates the message and then passes the message to a logical channel protocol module (LCPM) executing on the initiator storage system. The LCPM manages communication over the logical communication channel for various processes within the storage system. The LCPM constructs a SCSI write operation encapsulating the message and passes the write operation to the SAS initiator module. The SAS initiator module, in cooperation with the SAS controller, transmits the write operation onto the SAS domain where it is received by the SAS controller of the target storage system. The SAS controller on the target storage system alerts the SAS target mode module on the target storage system, which then prepares an appropriate buffer for the write data. The two SAS controllers cooperate to transfer the data from the initiator to the target storage system. The target SAS controller then alerts the target mode module that the write operation has completed. The SAS target mode module extracts the write data and passes it to the LCPM on the target storage system, which extracts the message and passes the message to the appropriate target process on the target storage system.

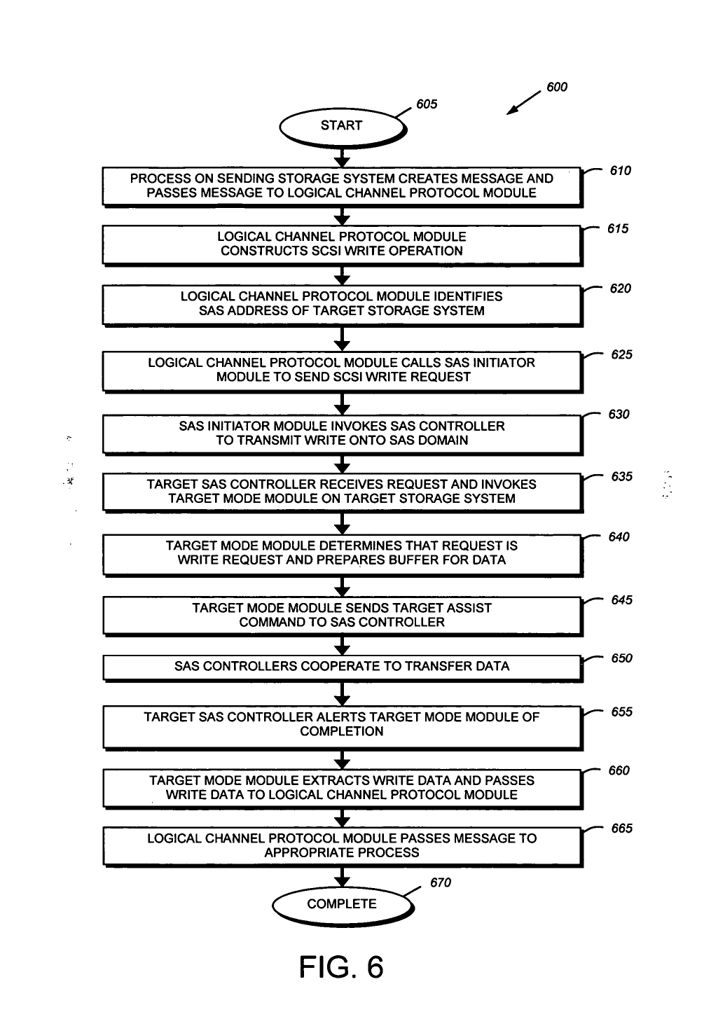

FIG. 6 is a flowchart detailing the steps of a procedure 600 for transmitting a message using the logical communication channel of the present invention. The procedure 600 begins in step 605 and continues to step 610 where a (initiating) process on the initiator storage system (the storage system from which the message is originating) creates a message and passes the message to the LCPM executing on the storage system. This message may be, for example, a heart beat message directed to a failover monitor on the target storage system. In response, the LCPM constructs SCSI write operation in step 615 and identifies the appropriate SAS address of the target storage system in step 620. The address may be identified by, for example, identifying a SAS address obtained during the previous initialization of the SAS domain. The SCSI write operation may be a conventional SCSI command descriptor block (CDB) describing a write operation directed to the SAS address of the target storage system. In step 625, the LCPM calls the SAS initiator module to send the SCSI write request. The SAS initiator module invokes the SAS controller to transmit the write operation onto the SAS domain.

The target SAS controller on the target storage system receives the request and invokes the SAS target mode module on the target storage system in step 635. The target mode module determines that the request is a write request and prepares appropriate buffers for the incoming data in step 640. The target mode module then sends a target assist command to the SAS controller on the target storage system in step 645. The target assist command causes the SAS controller to cooperate with the initiator SAS controller to transfer the data in step 650 in accordance with conventional SAS operations. In step 655, the target SAS controller alerts the SAS target mode module on the target storage system of the completion of the data transfer. The target mode module extracts the write data from the received SCSI command and passes the write data to the LCPM on the target storage system in step 660. The LCPM then passes the message, comprising the write data, to the appropriate (target) process executing on the target storage system (step 665). The procedure then completes in step 670.

The foregoing description has been directed to specific embodiments of this invention. It will be apparent, however, that other variations and modifications may be made to the described embodiments, with the attainment of some or all of their advantages. The procedures or processes described herein may be implemented in hardware, software, embodied as a computer-readable medium having program instructions, firmware, or a combination thereof. Therefore, it is the object of the appended claims to cover all such variations and modifications as come within the true spirit and scope of the invention.

What is claimed is:

1. A system for creating a logical communication channel between a first storage system and a second storage system, the system comprising:
a network operatively interconnecting the first storage system with the second storage system;
a target mode module executing on each storage system, the target mode module enabling each storage system to be accessed as a target device; and
a logical channel protocol module executing on each storage system, the logical channel protocol module adapted to cooperate with an initiator module to enable message passing over the network between the first and second storage systems.

2. The system of claim 1 wherein the network comprises a serial attached SCSI expander.

3. The system of claim 1 wherein each target mode module is adapted to perform a serial attached SCSI domain discovery procedure.

4. The system of claim 1 wherein network comprises a serial attached SCSI domain.

5. The system of claim 4 wherein the serial attached SCSI domain comprises one or more storage devices.

6. The system of claim 1 wherein each target mode module is adapted to receive write operations directed to the storage system.

7. The system of claim 1 wherein each target mode module is adapted to receive a write request from the logical channel protocol module.

8. A method for creating a logical communication channel between a first storage system and a second storage system using a serial attached SCSI domain, the method comprising the steps of:
constructing a protocol write operation having a message as write data;
identifying an address of the second storage system;
transmitting the write operation onto the serial attached SCSI domain;
detecting, by a controller operatively interconnected with the second storage system, the write operation;
preparing a buffer for incoming data; and
sending a target assist command to the controller.

9. The method of claim 8 further comprising the steps of;
alerting a target mode module of completion of the write operation; and
extracting the message from the received write operation.

10. The method of claim 8 wherein the serial attached SCSI domain comprises one or more serial attached SCSI expanders.

11. The method of claim 8 further comprising the step of transmitting the write data from the first storage system to the second storage system.

12. The method of claim 9 further comprising the step of forwarding the message to a process executing on the second storage system.

13. The method of claim 8 wherein the message comprises a heartbeat message.

14. A system for creating a logical communication channel between a first storage system and a second storage system using a serial attached SCSI domain, the system comprising:
means for constructing a protocol write operation having a message as write data;
means for identifying an address of the second storage system;
means for transmitting the write operation onto the serial attached SCSI domain;
means for detecting, by a controller operatively interconnected with the second storage system, the write operation;
means for preparing a buffer for incoming data; and
means for sending a target assist command to the controller.

15. The system of claim 14 further comprising:
the means for the steps of alerting a target mode module of completion of the write operation; and
means for extracting the message from the received write operation.

16. The system of claim 14 wherein the domain comprises one or more serial attached SCSI expanders.

17. The system of claim 14 further comprising means for transmitting the write data from the first storage system to the second storage system.

18. The system of claim 14 further comprising means for forwarding the message to a process executing on the second storage system.

19. The system of claim 14 wherein the message comprises a heartbeat message.

20. A computer readable medium for creating a logical communication channel between a first storage system and a second storage system using a serial attached SCSI domain, the computer readable medium including program instructions for performing the steps of:
constructing protocol write operation having a message as write data;
identifying an address of the second storage system;
transmitting the write operation onto the serial attached SCSI domain;
detecting, by a controller operatively interconnected with the second storage system, the write operation;
preparing a buffer for incoming data; and
sending a target assist command to the controller.
